(19) United States
(12) Patent Application Publication
(10) Pub. No.: US 2025/0182070 A1
(43) Pub. Date: Jun. 5, 2025

(54) SYSTEMS AND METHODS FOR CROSS PLATFORM SYNCHRONIZED PAYMENT SETTLEMENT

(71) Applicant: JPMORGAN CHASE BANK, N.A., New York, NY (US)

(72) Inventors: Naveen MALLELA, Singapore (SG); Umar FAROOQ, New York, NY (US); Nelli ZALTSMAN, New York, NY (US); Joshua DANIEL, Dartford (GB); Sai Murali Krishna VALIVETI, Singapore (SG); Alyssa Rachel I Ling KONG, London (GB); Aaron Paul DOYLE, Fareham (GB); Raunak RAJPURIA, Singapore (SG)

(21) Appl. No.: 18/962,321

(22) Filed: Nov. 27, 2024

Related U.S. Application Data
(60) Provisional application No. 63/604,719, filed on Nov. 30, 2023.

(51) Int. Cl. G06Q 20/06; G06Q 20/40; G06Q 40/02

(52) U.S. Cl. CPC G06Q 20/06; G06Q 20/4037; G06Q 40/02

(57) ABSTRACT

A method may include: a distributed application on a digital banking and payment platform receiving, via an API, a reserve funds instruction from a first transaction party to hold a balance in a blockchain deposit account, the reserve funds instruction comprising a reserve hold amount; the distributed application validating the reserve funds instruction; the distributed application generating a blockchain transaction payload for the reserve funds instruction; the distributed application submitting the blockchain transaction payload to a smart contract that maintains a distributed ledger, validates that the blockchain deposit account has available funds sufficient for the reserve hold amount, and creates a reserve funds hold on the reserve hold amount in the blockchain deposit account; the distributed application receiving, in response to a successful reserve funds hold, a confirmation event from the smart contract; and the distributed application generating a first reserve identifier for the reserve funds hold.

### RELATED APPLICATIONS

This application claims priority to, and the benefit of, U.S. Provisional Patent Application Ser. No. 63/604,719, filed Nov. 30, 2023, the disclosure of which is hereby incorporated, by reference, in its entirety.

### BACKGROUND OF THE INVENTION

### 1. Field of the Invention

Embodiments are generally directed to systems and methods for cross platform synchronized payment settlement.

### 2. Description of the Related Art

Digital currency platforms are becoming more and more popular, and it is fairly easy to make payments within a digital platform. Making a payment that occurs in a manner that is synchronized with, or in response to, another event that occurs outside the platform, such as the confirmation of a trade, or movement of an asset on another platform, however, causes difficulties, including difficulties in scheduling the payment and payment uncertainty.

### SUMMARY OF THE INVENTION

Systems and methods for cross platform synchronized payment settlement are disclosed. According to an embodiment, a method may include: (1) receiving, by a distributed application on a digital banking and payment platform and via an Application Programming Interface (API), a reserve funds instruction from a first transaction party to hold a balance in a blockchain deposit account, the reserve funds instruction comprising a reserve hold amount; (2) validating, by the distributed application, the reserve funds instruction; (3) generating, by the distributed application, a blockchain transaction payload for the reserve funds instruction; (4) submitting, by the distributed application, the blockchain transaction payload to a smart contract that maintains a distributed ledger, validates that the blockchain deposit account on the distributed ledger has available funds sufficient for the reserve hold amount, and creates a reserve funds hold on the reserve hold amount in the blockchain deposit account; (5) receiving, by the distributed application and in response to a successful reserve funds hold, a confirmation event from the smart contract; and (6) generating, by the distributed application, a first reserve identifier for the reserve funds hold.

In one embodiment, the reserve funds instruction may not associated with a specific transaction when the reserve funds instruction is received.

In one embodiment, the reserve funds instruction may be received from a delegate for the first transaction party. The delegate may include a digital asset platform.

In one embodiment, the reserve funds instruction may also include a reserve expiration.

In one embodiment, the method may also include storing, by an orchestration engine on a non-distributed ledger technology (DLT) banking platform, a status for the reserve funds and the first reserve identifier in an event store.

According to another embodiment, a method may include: (1) receiving, a distributed application on a digital banking and payment platform and via an Application Programming Interface (API), a prepare transfer instruction from a first transaction party to prepare a transfer of funds for a transaction, the prepare transfer instruction comprising payment details including a transaction amount and a transaction identifier; (2) sending, by an orchestration engine on a non-distributed ledger technology (DLT) banking platform, a request to the distributed application to reduce an amount in a blockchain deposit account for the first transaction party and to place a posting hold on the transaction amount in the blockchain deposit account with the transaction identifier; and (3) instructing, by the distributed application, a smart contract on a distributed ledger to execute the request.

In one embodiment, the distributed application assigns a posting hold identifier to the posting hold associated with the transaction identifier.

In one embodiment, the prepare transfer instruction further may include a second reserve identifier, and the method may also include: confirming, by the orchestration engine, that the second reserve identifier matches the first reserve identifier for a reserve funds hold; and confirming, by the orchestration engine, that a reserve hold amount is greater than or equal to the transaction amount; wherein the smart contract reduces an amount in the reserve funds hold and places a posting hold on the transaction amount in the blockchain deposit account.

In one embodiment, the method may also include: confirming, by the orchestration engine, that an amount in a blockchain deposit account is equal to or greater than the transaction amount; wherein the smart contract reduces an amount in the blockchain deposit account and places a posting hold on the transaction amount in the blockchain deposit account.

In one embodiment, the method may also include: storing, by the orchestration engine, a status for the posting hold and a posting hold identifier associated with the transaction identifier in an event store.

In one embodiment, the prepare transfer instruction may be received from a delegate for the first transaction party. The delegate may include a digital asset platform.

In one embodiment, the method may also include: receiving, by the distributed application on the digital banking and payment platform and from the first transaction party and via the API, an execute transfer instruction from the first transaction party to transfer funds for a transaction associated with the transaction identifier; executing, by the orchestration engine, a balance update call to the distributed application with a second transaction identifier; identifying, by the orchestration engine, a posting hold identifier using the transaction identifier; submitting, by the distributed application, a blockchain transaction for the execute transfer instruction to the smart contract; and processing, by the smart contract, the blockchain transaction by updating the posting hold to zero, decreasing a balance in a first transaction party account by the transaction amount, and increasing a balance in a second transaction party account by the transaction amount.

In one embodiment, the method may also include: generating, by the orchestration engine, a plurality of posting entries reflecting a debit to a first transaction party account and sending the plurality of posting entries to a ledger interoperability service on the non-DLT banking platform; and forwarding, by the ledger interoperability service, the plurality of posting entries to a posting generation service on the non-DLT banking platform, wherein the posting generation service validates and stores the plurality of posting entries.

In one embodiment, the method may also include: sending, by the posting generation service, the plurality of posting entries to a non-DLT ledger on the non-DLT banking platform.

In one embodiment, the method may also include: storing, by the orchestration engine, posting events for the plurality of posting entries to an event store.

In one embodiment, the method may also include: confirming, by the orchestration engine, that the second transaction identifier matches the transaction identifier; and confirming, by the orchestration engine, that the transaction associated with the transaction identifier is in an appropriate status for execution.

In one embodiment, the execute transfer instruction may be received from a delegate for the first transaction party. The delegate may include a digital asset platform.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for cross platform synchronized payment settlement according to an embodiment.

FIG. 2 depicts a method for cross platform synchronized payment settlement using a Reserve Funds Instruction is disclosed according to an embodiment.

FIGS. 3A and 3B depict a method for cross platform synchronized payment settlement using a Prepare Transfer instruction according to an embodiment.

FIGS. 4A and 4B depict a method for cross platform synchronized payment settlement using an Execute Transfer instruction according to an embodiment.

FIG. 5 depicts an exemplary computing system for implementing aspects of the present disclosure.

### DETAILED DESCRIPTION OF PREFERRED EMBODIMENTS

Systems and methods for cross platform synchronized payment settlement are disclosed.

Embodiments may enable persons or entities, such as clients of a financial institution, to better time payments to match the timing of any action which can be tracked separately to which the payment relates. Examples of actions may include the movement of assets (e.g., the purchase and sale of securities or the provision of collateral for financing), the tracking of shipments, the occurrence of corporate actions (e.g., the declaration of a dividend), etc. Embodiments may be directed to deposit accounts that may be maintained on a ledger using distributed ledger technology (a “DLT Ledger”). These deposit accounts may be referred to as “Blockchain Deposit Accounts” or “BDAs”.

Embodiments may also be directed to deposit accounts that may be maintained on an electronic ledger system commonly used by banking institutions (e.g., a “Non-DLT Ledger”) that does not use distributed ledger technology. These accounts may be referred to as “Demand Deposit Accounts” or “DDAs”.

In embodiments, a transfer request, such as a BDA to BDA transfer, or a BDA to DDA transfer, may be split into multiple sub-actions, such as a reserve funds action, which ringfences the funds in a BDA for a specified amount not associated with a specific transaction, a prepare transfer action, which ringfences the funds in a BDA in a “posting hold” for a specific transaction and executes control checks, and an execute transfer action, which executes the final balance movements related to the prepare transfer.

Embodiments may use two hold types, for example, a reserve hold type and a posting hold type, to execute these instructions. A reserve hold, which is caused by the “Reserve Funds” (or similar) instruction, is a hold placed on funds in a BDA for a specified amount resulting from the reserve funds request from an entity. A reserve hold draws on funds in the available balance in a BDA.

A posting hold, which is caused by the “Prepare Transfer” (or similar) instruction, is a hold placed on funds in a BDA for a specified amount resulting from a request from an entity. If the prepare transfer instructs use of a reserve hold, the posting hold will draw on funds in such reserve hold. Otherwise, the posting hold draws on funds in the available balance in a BDA.

Embodiments may use identifiers, such as a Reserve ID, a Posting Hold ID, and a Transaction ID.

The Reserve ID may be an identifier that is generated for a successfully placed reserve hold. The Reserve ID may be provided to the entity to use further instructions to draw on, modify or cancel the reserve.

The Posting Hold ID may be an identifier that is generated for a successfully placed posting hold resulting from a Prepare Transfer instruction request. The Posting Hold ID may be associated with a Transaction ID originating from the associated Prepare Transfer Request.

The Transaction ID may be a unique identifier that is provided in the header of a Prepare Transfer message.

Embodiments may further provide the ability to provide portable “proof” to payment originator or generate a push notice to beneficiary (or its delegee) when a transaction has been queued pursuant to the Prepare Transfer function. It may provide multi-party agreement mechanisms in relation to the cancelation of a Prepared Transfer instruction (e.g., a single party cannot cancel transaction), the execution of a Prepared Transfer instruction, etc.

Embodiments may automate the execution of a transfer using utilizing programmable payments using a trigger that sets a workflow in motion, (e.g., timers, receipt of payments, change in streaming rates, etc.), a condition being met (e.g., if certain keywords are found in payment transaction data if a balance is above a threshold, etc.), and execution of an action (e.g., payment initiation, foreign exchange swaps booking, balance movements, etc.).

In other embodiments, execution may be driven based on external events, such as the digital payment system consumption of cross-chain data. The execution may be based on other events, a schedule, etc.

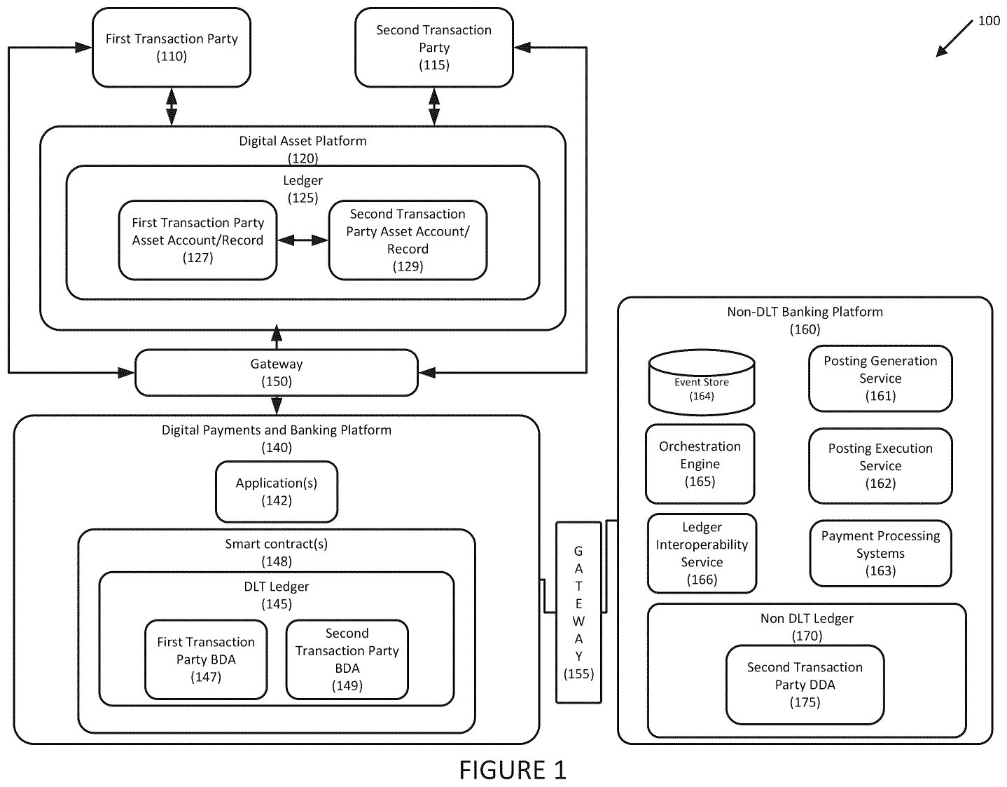

Referring to FIG. 1, a system for cross platform synchronized payment settlement is disclosed according to an embodiment. System 100 may include digital asset platform 120. Digital asset platform 120 may include any suitable type of electronic platform that may store events and/or asset ledgers or asset ownership.

Digital asset platform 120 may include ledger 125 which may maintain first transaction party asset account 127 for first transaction party 110, and second transaction party asset account 129 for second transaction party 115. First transaction party 110 and second transaction party 115 may access digital asset platform 120 using, for example, an electronic device, or other user interface.

It should be recognized that although only two transaction parties are illustrated in FIG. 1, additional transaction parties may be included as is necessary and/or desired.

System 100 may further include digital banking and payment platform 140. Digital banking and payment platform 140 may also include one or more applications 142, such as distributed applications (“DApps”), for performing certain tasks (e.g., validations, execution of business rules, etc.).

Digital banking and payment platform 140 may include DLT ledger 145, which may host first transaction party BDA 147 and second transaction party BDA 149. DApps may use smart contracts 148, to maintain the DLT Ledger 145 and carry out certain functions on the DLT ledger 145 like managing deposit account balances and hold balances.

First transaction party 110 and second transaction party 115 may optionally access digital banking and payment platform 140 using, for example, an electronic device or application programming interface (API). First transaction party 110 and second transaction party 115 may not be precluded from instructing digital banking and payment platform 140 directly via an application programming interface (API), even if the digital asset platform 120 is also instructing digital banking and payment platform 140 via API on the transaction party's behalf.

Digital banking and payment platform 140 may also connect to one or more non-DLT banking platforms, such as non-DLT banking platform 160. An example of such a connection is described in U.S. Pat. No. 11,615,413, the disclosure of which is hereby incorporated, by reference, in its entirety, may use ledger interoperability service (LIS) 166. Additionally, the Digital banking and payment platform 140 may also connect to one or more non-DLT banking platforms via API gateway, and use a combination of LIS 166 and the orchestration engine 165 to route data and instructions to other components of the non-DLT banking platform 160 for processing.

For example, non-DLT banking platform 160 may include a plurality of services, such as posting generation service 161 and posting execution service 162 for receiving and executing postings from digital banking and payment platform 140. Non-DLT banking platform 160 may include payment processing systems 163.

Non-DLT banking platform 160 may include non-DLT ledger 170, which may host DDAs, such as second transaction party DDA 175.

Non-DLT banking platform 160 may also include event store 164 and orchestration engine 165 for the processing and implementation of synchronized settlement capabilities, as well as general payment processing and routing of information between non-DLT banking platform 160 and digital banking and payment platform 140.

When Messages arrive at non-DLT banking platform 160 via gateway 155, they are either received by LIS 166 or orchestration engine 165 before being routed to the next relevant component.

Digital banking and payment platform 140 may interface with gateway 150, such as an API gateway, for receiving API calls from synchronized settlement APIs. The APIs may include a series of instructions to digital banking and payment platform 140, and callbacks/responses from digital banking and payment platform 140 to digital asset platform 120, to facilitate a workflow between digital asset platform 120 and digital banking and payment platform 140, in order to cause ultimate funds movement to occur (or stop) relative to events/asset status on digital asset platform 120. This may include the Reserve Funds, Prepare Transfer and Execute Transfer functions.

A similar gateway 155 may be provided between digital banking and payment platform 140 and non-DLT banking platform 160.

Applications 142 may connect to non-DLT banking platform 160 through gateway 155.

Digital banking and payment platform 140 may be configured to receive instructions to perform synchronized settlement capabilities from clients, such as first transaction party 110 and second transaction party 115 or their authorized delegees, such as digital asset platform 120 via an API. In the scenario where one or more of transaction parties 110 and/or 115 is acting through a delegate, such as digital asset platform 120, the delegate may pass the instruction from the respective transaction party to digital banking and payment platform 140 and provide encryption of the instruction before conveying it to the digital banking and payment platform 140, or it may generate the instruction in its entirety based on arrangements with the transaction parties and events occurring on the digital asset platform, such as the confirmation of a trade by the transaction parties. An example of such an instruction are the functions instructed through synchronized settlement APIs, such as Reserve Funds, Prepare transfer and Execute Transfer, described below.

A DApp constituting one of the applications 142 may also execute one or more smart contracts 148 that may be configured to create and release the reserve and posting holds, and manage amounts of funds held within the reserve and posting holds on DLT ledger 145, in response to instructions received by Digital banking and payment platform 140 through synchronized settlement APIs.

In embodiments, first transaction party 110 and second transaction party 115 may delegate authority to digital asset platform 120 (or other provider) to instruct synchronized settlement capabilities.

First transaction party 110 and second transaction party 115 may benefit from the DvP orchestration services of digital asset platform 120 (or other provider) that minimizes the effort of parties to integrate with digital banking and payment platform 140.

First transaction party 110 and second transaction party 115 may delegate all or certain functions. For example, first transaction party 110 or second transaction party 115 may want to set reserve fund amounts at the start of a trade day to ringfence funds to be used for trade activity, but delegate Prepare Transfer and Execute Transfer Functions to an asset platform for transaction execution instruction.

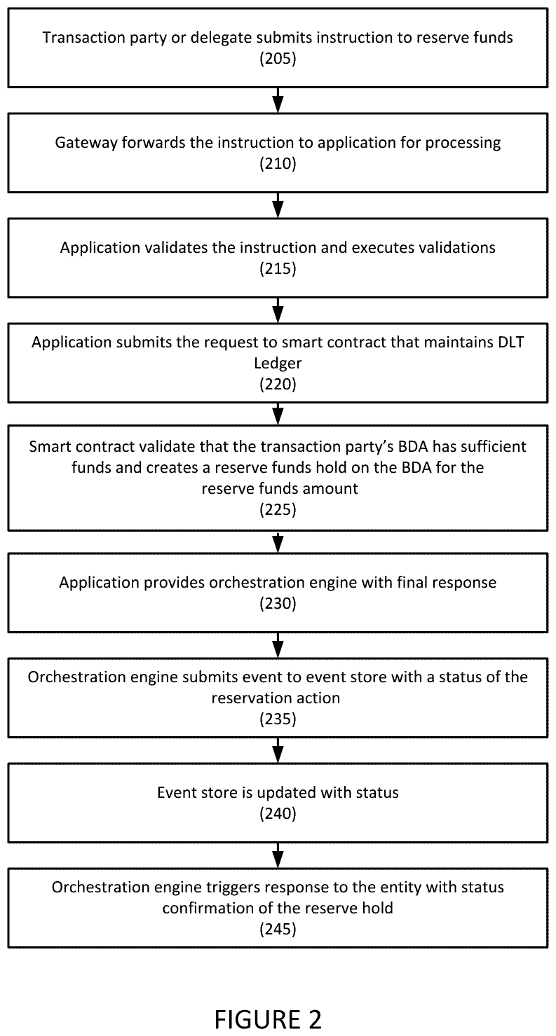

Referring to FIG. 2, a method for cross platform synchronized payment settlement using a Reserve Funds instruction is disclosed according to an embodiment.

In step 205, a transaction party or its delegate (such as a digital asset platform) may submit a request that may include an instruction, such as a Reserve Funds instruction to set aside a balance in a transaction party BDA to be held for transactions that may specifically reference an identifier, such as a Reserve ID, to a digital asset platform, and an amount, such as a transaction amount to be drawn down from the reserved funds. In one embodiment, the instruction may be received through the API gateway by the digital payments and banking platform. The Reserve Funds amount may be for all or part of the BDA balance. Multiple reserve holds may be placed in one BDA.

The transaction party or its delegate (such as a digital asset platform) may initiate the instruction to a gateway through an API.

The reserved funds amount may remain in the BDA and may be held in reserve for a specified time (e.g., 4 hours, 12 hours, 24 hours, etc.). During that time, the reserved funds may only be used for funds transfer instructions that contain the Reserve ID, such as Prepare Transfer instructions. If the entity later decides the reserved funds no longer need to be held in reserve, the entity may cancel the reserve. The reserve may also be increased or decreased using the same method of instruction.

Alternatively, if the reserved funds are not used in subsequent Prepare Transfer transaction instructions within the expiry period of the reserve, the hold on the reserved funds may be released. In each case, funds become part of the generally available balance in the BDA when the reserve is released or decreased.

In one embodiment, the request may be authenticated. For example, a computer program may authenticate the instruction at the gateway.

In step 210, the gateway may forward the instruction to an applicable application, such as a DApp, on the digital banking and payment platform for processing.

In step 215, the DApp may validate the instruction and may execute validations. Examples of validations may include account number validations, fund availability validations, etc.

Upon successful validation, the DApp may create a blockchain transaction payload for placing a reserve funds hold on the reserved fund amounts in the BDA.

In step 220, the DApp may submit the request to the smart contracts which maintain the DLT Ledger.

In step 225, one or more smart contracts on the DLT Ledger may validate that the entity's BDA has sufficient funds and, if validation is successful, may create the reserve funds hold on the BDA for the reserve funds amount. Confirmation of this action may be sent from the DLT Ledger to the DApp (e.g., the DApp may receive the event generated on the DLT platform).

In step 230, the DApp may provide the orchestration engine with a final response (e.g., confirming whether the Reserve Hold was placed). The final response may include the Reservation ID for successfully implemented reserves. In one embodiment, the DApp that submits the reserve request to the smart contract may generate the Reserve ID.

In step 235, the orchestration engine may submit an event to an event store with a status of the reservation action. For example, the status may indicate that the reserve has been placed, and associated Reserve ID. In one embodiment, the smart contract that places the hold may generate the Reserve ID.

In step 240, the event store may be updated with the status, such as to reflect that the reserve has been placed, and the Reserve ID.

In step 245, the orchestration engine may trigger a response to the transaction party or its delegate (such as a digital asset platform), for example, via the gateway, with a status confirmation of the reserve hold and a Reserve ID.

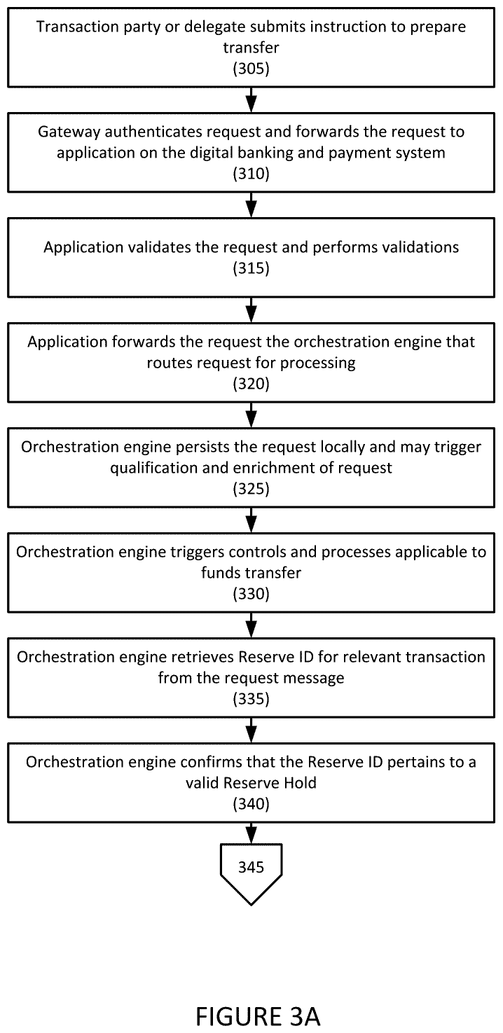

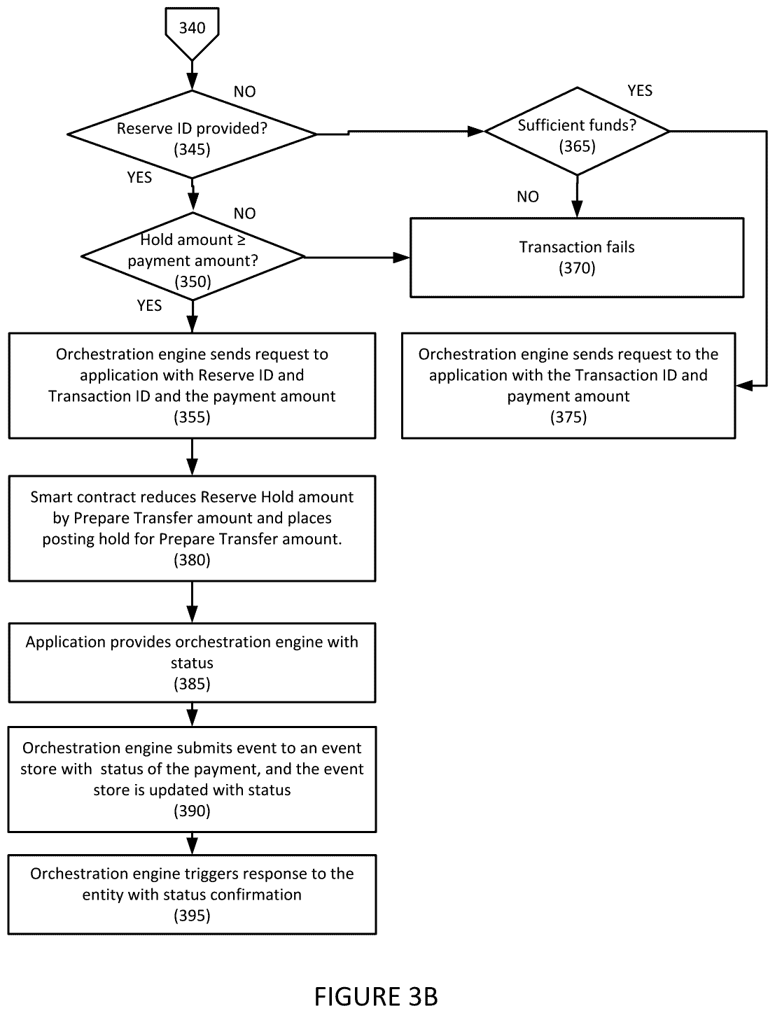

Referring to FIGS. 3A and 3B, a method for cross platform synchronized payment settlement using a Prepare Transfer instruction is disclosed according to an embodiment.

In step 305, a transaction party or its delegate (such as a digital asset platform) may submit a request that may include an instruction, such as a Prepare Transfer instruction.

In one embodiment, the message that communicates the Prepare Transfer instruction may include a Transaction ID. In one embodiment, the Transaction ID may be a unique identifier that is provided in the header of the message.

The transaction party or its delegate (such as a digital asset platform) may initiate the instruction to an API gateway.

In one embodiment, the instruction may be received through the API gateway by the Digital Payments and Banking Platform.

The Prepare Transfer instruction may be processed for either the general available balance in a BDA, or Reserved Funds if a Reserve ID is indicated in the instruction.

In one embodiment, the Prepare Transfer instruction may be put through the applicable controls checks and screening, and, if successful, the funds may be held, but may not be transferred without further instruction (e.g., an Execute Transfer instruction). Examples of control checks and screenings may include funds check, sanctions, other security checks, etc.

The transaction party or its delegate (such as a digital asset platform) may have the option to cancel the Prepare Transfer instruction should it later decide not to execute the transaction. The Prepare Transfer instruction may expire within a specified period of time after it is processed (e.g., a duration of hours, days, etc.) if an Execute Transfer instruction is not received in that time. If the Prepare Transfer instruction is canceled or expires, funds may be released from the hold and are made available to the transaction party for further transactions. The duration time before expiration is configurable.

In step 310, the gateway may authenticate the request and may forward the request to an applicable application, such as a DApp, on the digital banking and payment platform.

In step 315, the DApp may validate the request and may execute one or more validations, such as validation of a payload schema, a value date, etc.

In step 320, the application may forward the request to an orchestration engine on the non-DLT banking platform that may route the request for processing to the payment processing systems on the non-DLT banking platform.

In step 325, an orchestration engine may persist the request locally and may trigger qualification and enrichment of the request. For example, qualification may involve checking a set of business set rules, and enrichment may enrich data on a payload, such as by adding a zip code to an address, adding other internal data, etc.

In step 330, the orchestration engine on the non-DLT banking platform may trigger controls and processes applicable to funds transfer. This may include, for example, funds checks, sanction checks, other security checks, etc. performed via payment processing systems on the non-DLT banking platform.

In step 335, once controls and screening processes are successful, the orchestration engine on the non-DLT banking platform may retrieve the Reserve ID for the transaction from the request message.

In step 340, the orchestration engine on the non-DLT banking platform may confirm that the Reserve ID pertains to a valid Reserve Hold. For example, the orchestration engine on the non-DLT banking platform may make a call (e.g., an API call) to retrieve the Reserve Hold details from the relevant application (e.g., a DApp) associated with the smart contract managing the hold.

In step 345, the orchestration engine on the non-DLT banking platform may determine if the reserve hold exists. If it does not, the transaction may either fail or proceed to step 365 based on configurable system logic. If the reserve does exist, in step 350, the orchestration engine on the non-DLT banking platform may confirm that the reserve hold amount is greater than or equal to payment amount in the request message by requesting the hold information from the application. If it is, in step 355, the orchestration engine on the non-DLT banking platform may send a request to the application with two reference IDs (e.g., the Reserve ID and the Transaction ID for the request) and the payment amount, requesting the “prepare transfer” functions of reducing the reserve and placing the posting hold on relevant funds are performed. For example, the orchestration engine on the non-DLT banking platform may invoke an endpoint (e.g., an API end point) of the application for the DLT ledger on which BDA balances are maintained with the Reserve ID and the Transaction ID.

If no Reserve ID is provided, in step 365, the orchestration engine on the non-DLT banking platform may confirm that there are sufficient funds in the BDA available balance (not reserved) by requesting the account balance from the application. If there are, in step 375, the orchestration engine on the non-DLT banking platform may send a request to the application with the Transaction ID and the payment amount. For example, the orchestration engine on the non-DLT banking platform may invoke an endpoint (e.g., an API end point) of the application for the DLT ledger on which BDA balances are maintained with the Reserve ID and the Transaction ID requesting the “prepare transfer” functions of reducing the BDA available balance and placing the posting hold on relevant funds are performed. For example, the orchestration engine may invoke an endpoint (e.g., an API end point) of the application for the DLT ledger on which BDA balances are maintained with the Reserve ID and the Transaction ID.

If, in step 350 the reserve funds are insufficient, in step 370, the transaction may fail. If, in step 365, the BDA available balance is insufficient, in step 370, the transaction may fail.

Following step 355, in step 380, a smart contract on the DLT ledger may reduce the Reserve Hold by the Prepare Transfer amount and may place a posting hold for the Prepare Transfer amount, emitting an event that is relayed to the application. For example, a smart contract that maintains balances may adjust the balances upon receiving instructions from the DApp. The DApp may generate a Posting Hold ID.

In step 385, the DApp may provide the orchestration engine with a status for the hold management call (e.g., confirming if successful or failed), and the Posting Hold ID.

In step 390, the orchestration engine may submit an event to an event store with a status of the prepare transfer and the Posting Hold ID, and the event store may be updated with the status, as well as the Posting Hold ID to associate to the relevant Transaction ID. The Posting Hold ID may be used by the banking systems. It is not shared with the transaction party.

In step 395, the orchestration engine may trigger a response to the transaction party or its delegate (such as a digital asset platform), for example, via the gateway, with a status confirmation of the Prepare Transfer instruction (e.g., indicating if successful or failed).

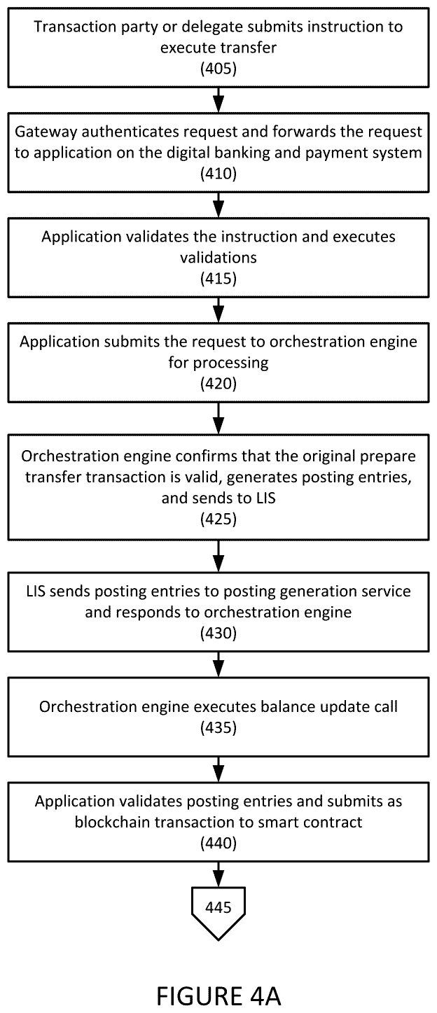

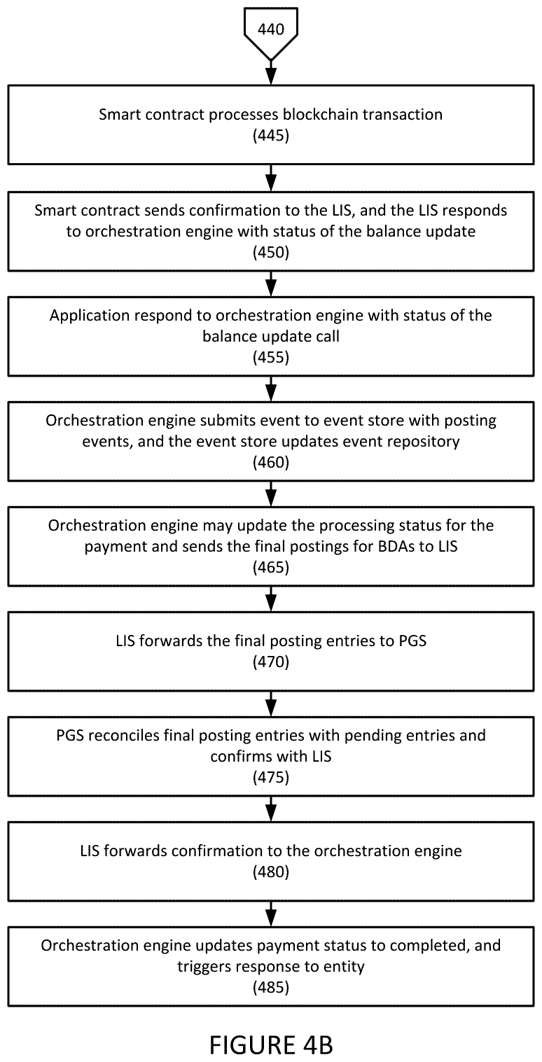

Referring to FIGS. 4A and 4B, a method for cross platform synchronized payment settlement using an Execute Transfer instruction is disclosed according to an embodiment.

For example, after the Execute Transfer instruction is received, the funds associated with the related prepared transfer identified in the Execute Transfer instruction may be released from the hold, debited from the transaction party's BDA, and credited to the destination BDA or DDA identified in the related Prepare Transfer instruction.

The effect of having separate Prepare Transfer and Execute Transfer instructions is to split the existing BDA to BDA or BDA to DDA transfer process into two steps to enable greater control of execution timing.

This may function to better time payment execution relative to the movement of assets and/or other activities tracked on other platforms (such as the tracking of shipments, or the occurrence of corporate actions (such as declaration of a dividend) to achieve approximately simultaneous payment with the other event, be it an asset settlement, shipment receipt, etc. Additionally, a transaction party may use these functions to ensure that it has adequate funds for forthcoming transactions over a certain period.

In step 405, a transaction party or its delegate (such as a digital asset platform) may submit a request that may include an instruction, such as an Execute Transfer instruction, to a digital asset platform. The Execute Transfer instruction may include the Transaction ID provided originally with related Prepare Transfer instruction.

In one embodiment, the instruction may be received through the API gateway by the digital payments and banking platform.

The transaction party or its delegate (such as a digital asset platform) may initiate the instruction to a gateway through an API.

In step 410, the gateway may authenticate the instruction and forward the instruction to an applicable application, such as a DApp, on the digital banking and payment platform for processing.

In step 415, an application, such as a DApp, may validate the request and may execute one or more preset business rule validations, such as validation of payload schema.

In step 420, the DApp may submit the request to an orchestration engine for processing.

In step 425, the orchestration engine may confirm that the original prepare transfer transaction is valid/in queue (e.g., by checking to see if there is a valid Posting Hold associated with the provided Transaction ID and that the necessary transaction status for the transaction associated with the Transaction ID has been achieved from prior controls checks), and may optionally perform orchestrate other checks as set by configurable system logic, such as revalidating funds availability, and upon successful validation generates posting entries that reflect the instructed debit and credit to applicable accounts, and may send the posting entries to a ledger interoperability service (LIS).

In step 430, the LIS may forward the posting entries to a Posting Generation Service (PGS) for validation, and may respond to the orchestration engine with confirmation of posting. An example of such is described in U.S. Provisional Patent Application No. 63/071,727 and U.S. patent application Ser. No. 17/460,784, the disclosures of each of which is hereby incorporated, by reference, in its entirety.

In one embodiment, the PGS may receive the posting entries and store the posting entries. The posting entries may be marked as pending at this stage. The PGS may respond to the LIS with confirmation that the posting entries are valid and have been stored.

Upon receiving the confirmation from PGS, the LIS may send the confirmation back to the orchestration engine.

In step 435, upon receiving response from LIS, the orchestration engine may execute a balance update call to the application with the Posting Hold ID associated with the relevant Transaction ID. The Posting Hold ID may be used to identify the relevant Posting Hold. Multiple Posting Holds may exist on one BDA.

In step 440, the DApp may validate the posting entries and may submit the entry as a blockchain transaction for processing to a smart contract on the DLT ledger.

In step 445, the smart contract may process the blockchain transaction. For example, the smart contract may release the Posting Hold by updating the Posting Hold to zero, and may update the balances of impacted BDAs (e.g., decrease balance of sender account, increase balance of receiver account if it is BDA).

If the receiver account is a DDA, the PGS may send the credit posting entry to non-DLT ledger of the bank.

In step 450, once complete, the smart contract may send confirmation to the LIS, and the LIS may respond to the orchestration engine with the status of the balance update on receiver DDA (if applicable).

In step 455, the DApp may respond to the orchestration engine with the status of the balance update call (e.g., success/failure) of BDAs (sender, and if applicable, receiver).

In step 460, the orchestration engine may submit an event to an event store with posting events for the completed posting entries, and the event store may update an event repository.

In step 465, the orchestration engine may update the processing status for the payment and sends the final postings for BDAs to LIS (if receiver is DDA, the LIS will receive final posting from a non-DLT ledger).

In step 470, the LIS may forward the final posting entries to the PGS.

In step 475, the PGS may reconcile the final posting entries with pending entries. After successful reconciliation, the PGS may mark the entries as complete, and may confirm the completed entries with the LIS.

In step 480, upon receiving the confirmation from the PGS, the LIS may forward the confirmation to the orchestration engine.

In step 485, the orchestration engine may update the payment status to completed, and may trigger a response to the transaction party or its delegate (such as a digital asset platform) (via a gateway) with status confirmation.

An illustrative example involving two transaction parties-a first transaction party and a second transaction party-is as follows. The first transaction party wants to hold a certain portion of its BDA funds for certain trading activities that will occur later in the day, but does not yet know the specific transactions. However, once the transactions are identified, the first transaction party may use the functions to better control timing of payment to the second transaction party (the seller of the asset) to correspond with transfer of the asset from the second transaction party to the first transaction party, which may occur on a separate platform at the direction of the first transaction party and the second transaction party.

In a first step, the first transaction party may initiate the Reserve Funds feature to hold funds in its BDA that will be used only for certain asset trading activity during a certain period.

Next, with no connection to the financial institution, the first transaction party may separately agree to act as a buyer of an asset and enter into an agreement and trade terms with the second transaction party to engage in a trade. The asset to be traded is held on an external platform.

Next, the first transaction party, who is the payor, may use the Prepare Transfer feature to prepare funds for transfer from the first transaction party's BDA to the second transaction party's BDA. Because funds were reserved in step 1 and the first transaction party has indicated a Reserve ID, funds will be drawn from Reserved Funds instead of the generally available balance of the first transaction party's BDA.

In this scenario, it is likely that the first transaction party will await confirmation that the asset to be sold is prepared for transfer according to procedures of the platform on which the asset is held before instructing the execution of funds transfer. In one embodiment, no financial institution may have visibility into the status of the asset transfer-it will be the first transaction party's determination as to when to instruct the transfer of funds.

In the alternative, the first transaction party may delegate authority to the asset platform, or other orchestration provider, to perform one or more of the above actions on its behalf. It is likely, in particular, that the authority to instruct Prepare Transfer and Execute Transfer on the transaction party's BDA will be delegated to the asset platform, or other orchestration provider. If not delegated fully, in the alternative the first transaction party may delegate authority to the asset platform to encrypt such instructions generated by the transaction party and relay to the digital banking and payments platform through the API Gateway.

Upon instruction by the first transaction party or its delegate (such as a digital asset platform) to execute the transfer, the funds are transferred from the first transaction party's BDA to the second transaction party's BDA. The first transaction party or its delegate (such as a digital asset platform) may instruct this transfer at such a time that the asset is transferred from the second transaction party to the first transaction party on an external platform. By having already completed the “Prepare Transfer” step, less time lag is likely between the movement of funds in the Execute Transfer step, and the separately occurring external asset movement. As a result, the first transaction party is better able to coordinate the two legs of the transaction.

By employing the features of Reserve Funds, Prepare Transfer, and Execute Transfer, the transaction parties are able to time the transfer of funds and assets with improved control, without the financial institution that is moving funds participating in the asset transfer.

While the above illustrative example describes a use case in which the functions are used in asset trading and funds settlement, these features may be used in other use cases. Some examples include exchange of loan proceeds with collateral, exchange of one currency for another, the occurrence of corporate events tracked on a platform (such as the announcement of dividends), the shipment of goods and other transaction party-driven use cases.

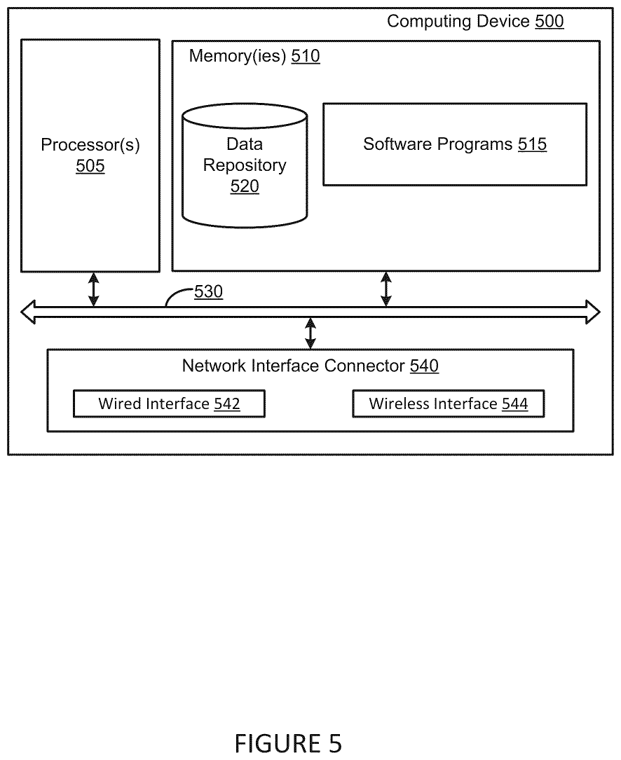

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, that may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a distributed application on a digital banking and payment platform and via an Application Programming Interface (API), a reserve funds instruction from a first transaction party to hold a balance in a blockchain deposit account, the reserve funds instruction comprising a reserve hold amount;
validating, by the distributed application, the reserve funds instruction;
generating, by the distributed application, a blockchain transaction payload for the reserve funds instruction;
submitting, by the distributed application, the blockchain transaction payload to a smart contract that maintains a distributed ledger, validates that the blockchain deposit account on the distributed ledger has available funds sufficient for the reserve hold amount, and creates a reserve funds hold on the reserve hold amount in the blockchain deposit account;
receiving, by the distributed application and in response to a successful reserve funds hold, a confirmation event from the smart contract; and
generating, by the distributed application, a first reserve identifier for the reserve funds hold.

2. The method of claim 1, wherein the reserve funds instruction is not associated with a specific transaction when the reserve funds instruction is received.

3. The method of claim 1, wherein the reserve funds instruction is received from a delegate for the first transaction party.

4. The method of claim 3, wherein the delegate comprises a digital asset platform.

5. The method of claim 1, wherein the reserve funds instruction further comprises a reserve expiration.

6. The method of claim 1, further comprising:
storing, by an orchestration engine on a non-distributed ledger technology (DLT) banking platform, a status for the reserve funds and the first reserve identifier in an event store.

7. A method, comprising:
receiving, a distributed application on a digital banking and payment platform and via an Application Programming Interface (API), a prepare transfer instruction from a first transaction party to prepare a transfer of funds for a transaction, the prepare transfer instruction comprising payment details including a transaction amount and a transaction identifier;
sending, by an orchestration engine on a non-distributed ledger technology (DLT) banking platform, a request to the distributed application to reduce an amount in a blockchain deposit account for the first transaction party and to place a posting hold on the transaction amount in the blockchain deposit account with the transaction identifier; and
instructing, by the distributed application, a smart contract on a distributed ledger to execute the request.

8. The method of claim 7, wherein the distributed application assigns a posting hold identifier to the posting hold associated with the transaction identifier.

9. The method of claim 7, wherein the prepare transfer instruction further comprises a second reserve identifier, and further comprising:
confirming, by the orchestration engine, that the second reserve identifier matches a first reserve identifier for a reserve funds hold; and
confirming, by the orchestration engine, that a reserve hold amount is greater than or equal to the transaction amount;
wherein the smart contract reduces an amount in the reserve funds hold and places a posting hold on the transaction amount in the blockchain deposit account.

10. The method of claim 7, further comprising:
confirming, by the orchestration engine, that an amount in a blockchain deposit account is equal to or greater than the transaction amount;
wherein the smart contract reduces an amount in the blockchain deposit account and places a posting hold on the transaction amount in the blockchain deposit account.

11. The method of claim 7, further comprising:
storing, by the orchestration engine, a status for the posting hold and a posting hold identifier associated with the transaction identifier in an event store.

12. The method of claim 7, wherein the prepare transfer instruction is received from a delegate for the first transaction party.

13. The method of claim 12, wherein the delegate comprises a digital asset platform.

14. The method of claim 7, further comprising:
receiving, by the distributed application on the digital banking and payment platform and from the first transaction party and via the API, an execute transfer instruction from the first transaction party to transfer funds for a transaction associated with the transaction identifier;
executing, by the orchestration engine, a balance update call to the distributed application with a second transaction identifier;
identifying, by the orchestration engine, a posting hold identifier using the transaction identifier;
submitting, by the distributed application, a blockchain transaction for the execute transfer instruction to the smart contract; and
processing, by the smart contract, the blockchain transaction by updating the posting hold to zero, decreasing a balance in a first transaction party account by the transaction amount, and increasing a balance in a second transaction party account by the transaction amount.

15. The method of claim 14, further comprising:
generating, by the orchestration engine, a plurality of posting entries reflecting a debit to a first transaction party account and sending the plurality of posting entries to a ledger interoperability service on the non-DLT banking platform; and
forwarding, by the ledger interoperability service, the plurality of posting entries to a posting generation service on the non-DLT banking platform, wherein the posting generation service validates and stores the plurality of posting entries.

16. The method of claim 15, further comprising:
sending, by the posting generation service, the plurality of posting entries to a non-DLT ledger on the non-DLT banking platform.

17. The method of claim 15, further comprising:
storing, by the orchestration engine, posting events for the plurality of posting entries to an event store.

18. The method of claim 14, further comprising:
confirming, by the orchestration engine, that the second transaction identifier matches the transaction identifier; and
confirming, by the orchestration engine, that the transaction associated with the transaction identifier is in an appropriate status for execution.

19. The method of claim 14, wherein the execute transfer instruction is received from a delegate for the first transaction party.

20. The method of claim 19, wherein the delegate comprises a digital asset platform.
